(19) United States
(12) Patent Application Publication
(10) Pub. No.: US 2020/0096344 A1
(43) Pub. Date: Mar. 26, 2020

(54) PLANNING METHOD OF A FLIGHT OF AN AIRCRAFT, ASSOCIATED DISPLAY, COMPUTER PROGRAM PRODUCT AND PLANNING SYSTEM

(71) Applicant: THALES, Courbevoie (FR)

(72) Inventors: Florent Mennechet, Merignac (FR); Valéry Bota, Merignac (FR)

(21) Appl. No.: 16/579,580

(22) Filed: Sep. 23, 2019

(30) Foreign Application Priority Data
Sep. 26, 2018 (FR) 18 00998

(51) Int. Cl. G01C 21/20; G06F 3/0488; G06F 3/14

(52) U.S. Cl. CPC G01C 21/20; G06F 3/1423; G06F 3/04883

(57) ABSTRACT

The invention relates to a flight planning method for planning a flight of an aircraft controllable by at least one pilot and comprising a flight management system and a head-down display screen, the flight planning method comprising of the following steps;
acquisition of an information item relating to a tactile motion effected by the pilot on the head-down display screen, the head-down display screen displaying a geographical map of the environment of the aircraft;
association of the information relating to the tactile motion of the pilot with a first set of geographical points of the geographical map, the first set of geographical points being capable of being used by the flight management system; and
displaying of the first set of geographical points on the head-down display screen.

### CROSS-REFERENCE TO RELATED APPLICATIONS

This application is a U.S. non-provisional application claiming the benefit of French Application No. 18 00998, filed on Sep. 26, 2018, which is incorporated herein by reference in its entirety.

### FIELD OF THE INVENTION

The present invention relates to a flight planning method for planning a flight of an aircraft that may be piloted by at least one pilot and comprising a flight management system and a tactile display screen, the display screen displaying a map of the environment of the aircraft.

The present invention also relates to a computer program product and an associated planning system.

### BACKGROUND

It is a known practice to plan the flight of the aircraft in advance of the take-off by defining a flight plan and the planned trajectory or flight path to be followed by the aircraft. However, the defining of the trajectory or flight path is carried out point by point, with each point being entered manually in the flight management system.

The definition of the trajectory is therefore a long and unintuitive process. In particular, it is a complicated task for the pilot to modify this trajectory or to add additional information into the flight management system during the flight undertaken by the aircraft.

### SUMMARY

The present invention therefore serves the object of improving the communication between the flight management system and the pilot.

To this end, the object of the invention relates to a flight planning method for planning a flight in an aircraft that may be piloted by at least one pilot and comprising a flight management system and a tactile display screen, the flight planning method comprising of the following steps;
acquisition of an information item relating to a tactile motion effected by the pilot on the head-down display screen, the head-down display screen displaying a geographical map of the environment of the aircraft;
association of the information relating to the tactile motion of the pilot with a first set of geographical points of the geographical map, the first set of geographical points being capable of being used by the flight management system; and
displaying of the first set of geographical points on the head-down display screen.

According to other advantageous aspects of the invention, the flight planning method comprises one or more of the following characteristic features, taken into consideration in isolation or in accordance with any technically possible combination;
the flight planning method in addition comprises a data transmission step for transmitting the first set of geographical points to a remote system located at a distance from of the aircraft;
the flight planning method in addition comprises a data reception step for receiving at least one second set of geographical points from the exterior of the aircraft and a display step for displaying the second set of geographical points on the head-down display screen;
the flight planning method in addition comprises a display step for displaying the first set of geographical points on a head-up display screen of the aircraft;
the information acquired upon the tactile motion being effected by the pilot along a closed line is the inner surface area defined by the closed line, the first set of geographical points then being a geographical zone of interest for the flight management system;
the flight planning method in addition comprises a trajectory construction step for constructing a trajectory of the aircraft programmed into the flight management system based on the first set of geographical points associated with the tactile motion effected by the pilot along an open line;
the flight planning method comprises a validation or voiding step for the pilot to validate or void the display; and
the flight planning method comprises a data storage step for storing the set of geographical points in an internal memory storage of the aircraft.

The object of the invention also relates to a computer program product comprising of software instructions which, when operationally implemented by a computer unit, implement a flight planning method as defined here above.

The object of the invention also relates to a flight planning system configured so as to be installed on-board in an aircraft controllable by at least one pilot and comprising a flight management system and a tactile head-down display screen, the head-down display screen being configured so as to display a geographical map of the environment of the aircraft; the planning system including;
a data acquisition module configured so as to acquire a tactile motion effected by the pilot on the head-down display screen;
a data processing module configured so as to associate the tactile motion of the pilot with a first set of geographical points of the map capable of being used by the flight management system; and
a visualization module configured so as to display the first set of geographical points on the head-down display screen.

### BRIEF DESCRIPTION OF THE DRAWINGS

These characteristic features and advantages of the invention will become apparent upon reading the description that follows, given solely by way of non-limiting example, and with reference being made to the appended drawings, in which;

FIG. 1 is a schematic view of a flight planning system according to the invention arranged in an aircraft;

FIG. 2 is a schematic side view of a cockpit of the aircraft represented in FIG. 1;

FIG. 3 is a schematic view of the interior of the cockpit represented in FIG. 2;

FIG. 4 is a flowchart of a planning method according to the invention, the method being operationally implemented by means of the display system represented in FIG. 1.

### DETAILED DESCRIPTION

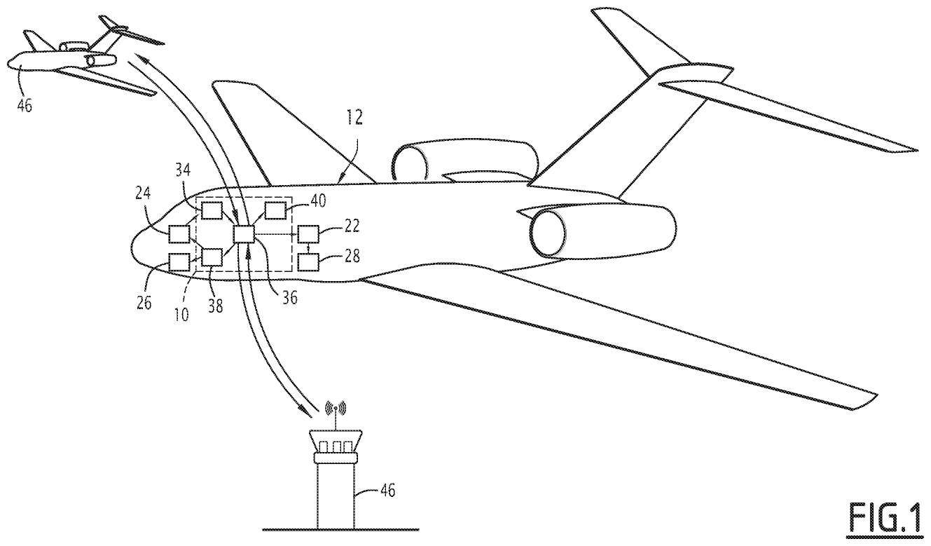

A flight planning system 10 is represented in FIG. 1. This system 10 is installed on-board in an aircraft 12.

Here the term aircraft 12, is used to refer to any airplane or helicopter or other flying vehicle that may be piloted by a pilot 14 from this vehicle.

According to another exemplary embodiment, the aircraft 12 is a drone that may be remotely piloted or controlled. In this case, the planning system 10 is disposed in a control centre, for example ground-based, from which the piloting/control of the drone is carried out.

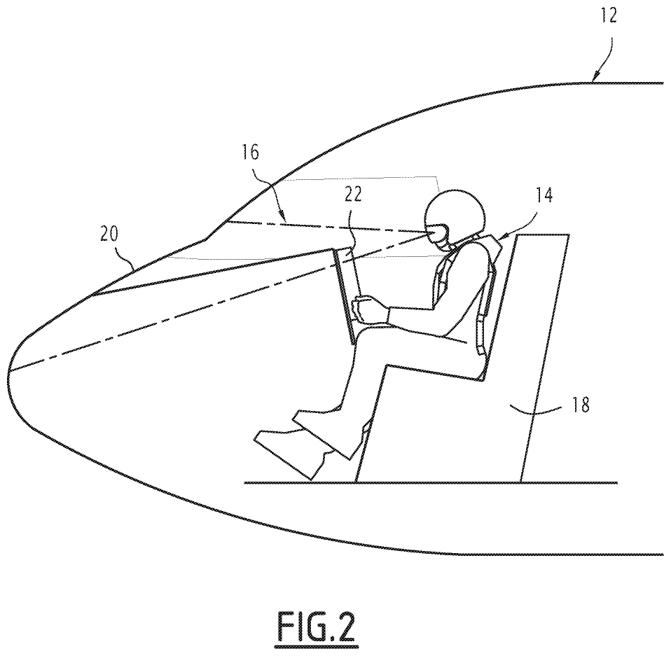

As can be seen in FIG. 2, the aircraft 12 comprises a cockpit 16.

The cockpit 16 includes at least one seat 18 for the pilot 14 and a windshield 20 that is at least partially transparent and separating the interior of the cockpit 16 from the exterior environment 12 outside the aircraft.

The aircraft 12 in addition comprises a flight management system 22 and a head-down display screen 24.

In one advantageous embodiment, the aircraft 12 in addition comprises a head-up display screen 26.

The Flight Management System 22 (as per the accepted terminology) is a computing unit installed on-board in the aircraft 12 equipped with a software application configured so as to assist the pilot 14 during the flight of the aircraft 12 by providing for example, data and information relating to the piloting, navigation, fuel consumption, etc.

The flight management system 22 is additionally also configured so as to determine a trajectory of the aircraft 12 based on a set of geographical points provided by the pilot 14.

The flight management system 22 is advantageously configured so as to optimize this trajectory as a function of the constraints related to cost or duration of the flight, and based as well on the geographical zones of interest to be targeted or avoided.

The flight management system 22 is advantageously coupled to an automatic piloting system 28 for automatically piloting the aircraft 12 which is configured so as to guide the aircraft 12 without human intervention along the trajectory defined by the pilot 14.

The head-down display screen 24 is disposed in the cockpit 16 so as to face the pilot 14.

The head-down display screen 24 is configured so as to display data and information in the aircraft 12. In particular, the head-down display screen 24 is configured so as to display a geographical map of the environment of the aircraft 12.

The geographical map is a schematic representation of the environment of the aircraft 12.

The geographical map consists of a set of geographical points, each geographical point being associated with a precise locational position of the environment of the aircraft 12.

Each geographical point is defined by its geographical coordinates, for example, by its latitude and longitude.

The head-down display screen 24 is also tactile. It is configured so as to detect each tactile motion effected by the pilot 14 on the head-down display screen 24.

The head-up display screen 26 is disposed in the cockpit 16 so as to face the pilot 14.

The head-up display screen 26 is at least partially transparent.

Advantageously, the head-up display screen 26 is a visor that is integrated into a helmet 30 that is suitable to be worn by the pilot 14, as can be seen in FIG. 2.

The head-up display screen 26 is configured so as to display data and information which are, for the pilot 14, superimposed over the exterior environment of the aircraft 12.

This type of display is referred to as a “conforming” display because the data and information displayed are placed over the actual positions of the external elements and thus makes it possible to display data and information relating to the actual landscape. In order to do this, this type of display depends directly on the position of the aircraft 12, on the attitude of the aircraft 12, and on the orientation of the axis of vision of the pilot 14.

As opposed to the term “conforming”, the type of display of the head-down display screen 24 mentioned above, is in the state of the art referred to by the term “non-conforming”. In particular, this type of display depends on the velocity vector of the aircraft 12 and does not change with changes in the attitude of the latter.

The head-up display screen 26 is disposed between the eyes of the pilot 14 and the windshield 20 of the aircraft 12.

By way of a variant, the head-up display screen 26 is a fixed transparent surface installed within the cockpit 16 and placed in front of the pilot 14.

The flight planning system 10 comprises a data acquisition module 34, a data processing module 36, a visualization module 38 and an internal memory storage 40.

Each module 34, 36, 38 of the planning system 10 is present for example in the form of a software application that is operationally implemented by a suitable computer unit and/or at least partially by a programmable logic circuit, for example of the type FPGA (Field Programmable Gate Array as per the accepted terminology).

The data acquisition module 34 is configured so as to acquire information relating to each tactile motion effected by the pilot 14 on the head-down display screen 24. With the head-down display screen 24 displaying the geographical map of the environment of the aircraft 12, the tactile motion of the pilot 14 is effected by way of superimposing it over the geographical map.

In particular, the data acquisition module 34 is configured so as to acquire a geometric shape associated with the tactile motion.

The data acquisition module 34 is in addition configured so as to detect whether the tactile motion of the pilot 14 is effected along an open line 42 or a closed line 44.

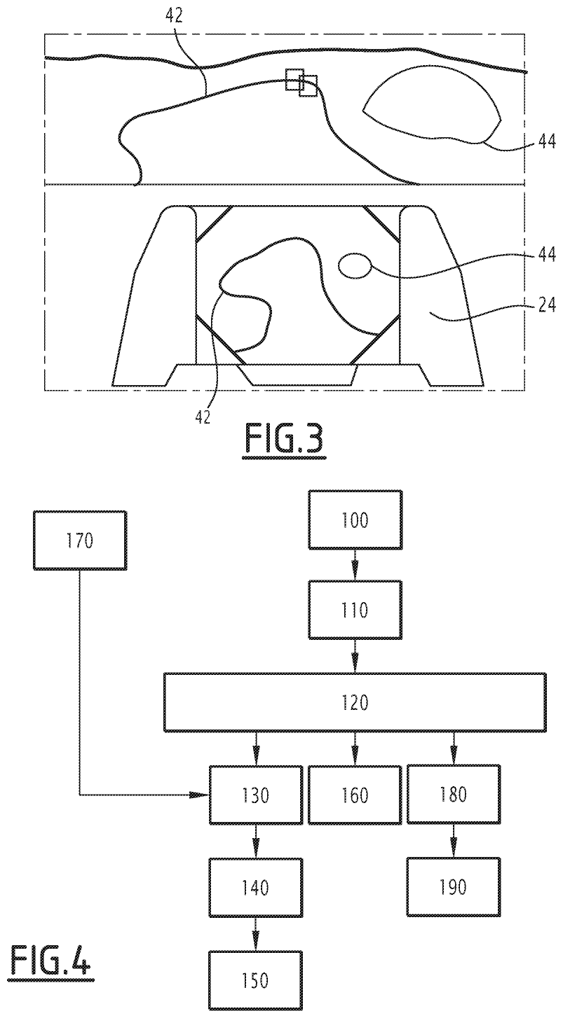

As can be seen in FIG. 3, the term “open line” is used to refer to a line whose end-points are not merged together.

Conversely, the term “closed line” is used to refer to a line whose end-points are merged together.

Upon the tactile motion being effected by the pilot 14 along an open line 42, the shape acquired by the data acquisition module 34 is directly the open line 42.

Upon the tactile motion being effected by the pilot 14 along a closed line 44, the form acquired by the data acquisition module 34 is the inner surface area defined by the closed line 44.

The data acquisition module 34 is configured so as to send the acquired form to the data processing module 36.

The data processing module 36 is configured so as to associate the tactile motion effected by the pilot 14, in particular the form acquired by the data acquisition module 34, to a first set of geographical points of the geographical map.

In particular, the data processing module 36 is configured so as to associate with each point of the tactile motion on the head-down display screen 24, the geographical point of the map that is tactilely pointed by the pilot 14 on the map by taking into account the relief of the geographical map.

Upon the tactile motion being effected by the pilot 14 along an open line 42, the first set of geographical points is thus then a line.

Upon the tactile motion being effected by the pilot 14 along a closed line 44, the first set of geographical points is thus then a two-dimensional zone.

The data processing module 36 is configured so as to send the position of the first set of geographical points to the flight management system 22.

The data processing module 36 is in addition advantageously configured so as to send the position of the first set of geographical points to at least one remote system 46 that is at a distance from the aircraft 12.

The remote element 46 is for example a surrounding aircraft or control tower, as can be seen in FIG. 1.

The data processing module 36 is in addition advantageously configured so as to receive at least one second set of geographical points sent by at least one remote element 46. The data processing module 36 is configured so as to send the position of the second set of geographical points to the flight management system 22 and to the visualization module 38.

In addition, the data processing module 36 is advantageously configured so as to store the at least one set of geographical points in the internal memory storage 40 of the aircraft 12.

The at least one set of geographical points is capable of being used by the flight management system 22.

In particular, the flight management system 22 is configured so as to construct a trajectory of the aircraft 12 based on the set of geographical points associated with the tactile motion effected by the pilot 14 along an open line 42, and advantageously based on the at least one second set of geographical points received from the remote element 46.

The flight management system 22 is also configured so as to take into account in the computing of the trajectory the geographic zone of interest based on the set of geographical points associated with the tactile motion effected by the pilot 14 along a closed line 44, and advantageously based on the at least one second set of geographical points received from the remote element 46.

The flight management system 22 is configured so as to send the constructed trajectory of the aircraft 12 to the automatic piloting system 28.

The visualization module 38 is configured so as to display the set of geographical points on the head-down display screen 24.

Advantageously, the visualization module 38 is configured so as to in addition display the set of geographical points on the head-up display screen 26.

The visualization module 38 is additionally also configured so as to display on the head-down display screen 24, at least one button that enables the pilot 14 to validate or void the display of the set of geographical points on the head-down display screen 24 and the head-up display screen 26.

The data acquisition module 34 is configured so as to detect the contact of a finger of the pilot 14 on the at least one button and to send the information to the data processing module 36.

The data acquisition module 34 is configured so as to detect the contact of a finger of the pilot 14 on the at least one button and to send the information to the data processing module 36.

The data processing module 36 is configured so as to void the display of the set of geographical points on the display screens 24, 26 in the event of a request to void from the pilot 14.

The data processing module 36 is advantageously configured so as to store the at least one set of geographical points in the internal memory storage 40 of the aircraft 12 in the event of a validation request from the pilot 14.

A flight planning method for planning a flight within an aircraft 12 according to the invention will now be described with reference made to FIG. 4 that presents a flowchart of the steps thereof.

Initially, the pilot 14 is installed in the cockpit 16.

During the initial step 100, the pilot moves at least one finger on the tactile head-down display screen 24.

Then, during the step 110, the data acquisition module 34 acquires an information item relating to the tactile motion effected by the pilot 14 on the head-down display screen 24.

In particular, the data acquisition module 34 acquires a geometric form associated with the tactile motion.

The data acquisition module 34 furthermore detects whether the tactile motion effected by the pilot 14 occurs along an open line 42 or a closed line 44.

The data acquisition module 34 then sends the information associated with the tactile motion to the data processing module 36.

During the step 120, the data processing module 36 associates the information item relating to the tactile motion effected by the pilot 14 with a first set of geographical points of the geographical map capable of being used by the flight management system 22.

In particular, where the tactile motion effected by the pilot 14 is along an open line 42, the first set of geographical points is thus then a line.

Where the tactile motion effected by the pilot 14 is along a closed line 44, the first set of geographical points is thus then a two-dimensional zone.

The data processing module 36 sends the position of the set of geographical points to the visualization module 38 and to the flight management system 22.

Then, during the step 130, the visualization module 38 displays the set of geographical points on the head-down display screen 24.

Advantageously, the visualization module 38 also displays the set of geographical points on the head-up display screen 26.

Then, the planning method includes an optional validation or voiding step 140 for the pilot 14 to validate or void the display of the geographical points on the screens 24, 26.

Following the validation by the pilot 14 during the step 140, during the step 150, the set of geographical points is stored in the internal memory storage 40 of the aircraft 12.

Following the step 120, the flight planning method advantageously includes a data transmission step 160 for transmitting the set of geographical points to the at least one remote system 46 located at a distance from the aircraft 12.

In parallel with the steps 100 to 120, the flight planning method advantageously comprises a data reception step 170 for receiving at least one second set of geographical points from the exterior of the aircraft 12. The second set of geographical points is sent by the least one remote system 46 which is possibly different from the one in step 160.

Then, the second set of geographical points is displayed on the head-down display screen 24 and advantageously on the head-up display screen 26 during the step 130.

Following the step 120, the flight management system 22 constructs a trajectory of the aircraft 12 based on the set of geographical points associated with the tactile motion effected by the pilot 14 along an open line 42 and advantageously based on the at least one second set of geographical points received from the remote unit 46.

The flight management system 22 also takes into account in the computing of the trajectory the geographical zone of interest based on the set of geographical points associated with the tactile motion effected by the pilot 14 along a closed line 44, and advantageously based on the at least one second set of geographical points received from the remote element 46.

The flight management system 22 then sends the trajectory constructed of the aircraft 12 to the automatic piloting system 28.

During a step 190, the automatic piloting system 28 guides the aircraft 12 without human intervention, along the trajectory as defined by the pilot 14.

It may be understood that the present invention provides a certain number of advantages.

First of all, the flight planning method according to the invention provides the ability to undertake rapid development of trajectories and strategy. In fact, the tactile mode of defining the trajectories and zones of interest on the head-down display screen 24 is very intuitive for the pilot 14.

The trajectory of the aircraft 12 may be easily reprogrammed during the flight and the pilot 14 is able to easily incorporate information relating to obstacles or new geographic objectives to be taken into account.

The invention thus improves the communication between the flight management system 22 and the pilot 14.

In addition, the flight planning method provides for improved communication between the pilot 14 and the remote elements 46 located exterior to the aircraft 12 such as the surrounding aircrafts or a control tower.

The sharing of trajectory or geographical zones data is done without any need for using speech and therefore serves to greatly facilitate both communication and comprehension. Indeed, the forms in question are universally recognized and therefore not dependent on the language, the cultural background or the age of the pilot 14.

Thus, thanks to the invention it is easy to rapidly establish strategies or modifications of trajectories in collaboration with the remote elements 46. The invention thus makes it possible to achieve significant time savings and improve responsiveness of the pilot 14 in case of unforeseen situations.

Finally, the storage of the geographical points in the internal memory storage 40 makes it possible to obtain historical data on the geographical points and ensure information sharing with the various remote elements 46 over time in order to facilitate the development of future flights of the aircraft 12.

1. A flight planning method for planning the flight of an aircraft controllable by at least one pilot and comprising;
a flight management system; and
a tactile head-down display screen;
the flight planning method comprising of the following steps;
acquisition of an information item relating to a tactile motion effected by the pilot on the head-down display screen, the head-down display screen displaying a geographical map of the environment of the aircraft;
association of the information relating to the tactile motion of the pilot with a first set of geographical points of the geographical map, the first set of geographical, points being capable of being used by the flight management system; and
displaying of the first set of geographical points on the head-down display screen.

2. The flight planning method according to claim 1, in addition comprising a data transmission step for transmitting the first set of geographical points to a remote system located at a distance from the aircraft.

3. The flight planning method according to claim 1, in addition comprising a data reception step for receiving at least one second set of geographical points from the exterior of the aircraft and a display step for displaying the second set of geographical points on the head-down display screen.

4. The flight planning method according to claim 1, in addition comprising a display step for displaying the first set of geographical points on a head-up display screen of the aircraft.

5. The flight planning method according to claim 1, in which the information acquired upon the tactile motion being effected by the pilot along a closed line is the inner surface area defined by the closed line, the first set of geographical points then being a geographical zone of interest for the flight management system.

6. The flight planning method according to claim 1, in addition comprising a trajectory construction step for constructing a trajectory of the aircraft programmed in the flight management system based on the first set of geographical points associated with the tactile motion effected by the pilot along an open line.

7. The flight planning method according to claim 1, comprising a validation or voiding step for the pilot to validate or void the display,

8. The flight planning method according to claim 1, comprising a data storage step for storing the set of geographical points in an internal memory storage of the aircraft.

9. A computer program product comprising of software instructions which, when operationally implemented by a computer unit, implement the flight planning method according to claim 1.

10. A flight planning system configured so as to be installed on-board in an aircraft that may be piloted by at least one pilot and comprising;
a flight management system; and
a head-down display screen, the head-down display screen being configured so as to display a geographical map of the environment of the aircraft;
the planning system including;
a data acquisition module configured so as to acquire a tactile motion effected by the pilot on the head-down display screen;
a data processing module configured so as to associate the tactile motion of the pilot with a first set of geographical points of the map capable of being used by the flight management system; and
a visualization module configured so as to display the first set of geographical points on the head-down display screen.
